(19) United States
(12) Patent Application Publication
(10) Pub. No.: US 2025/0286828 A1
(43) Pub. Date: Sep. 11, 2025

(54) Sideband interface using CQEs

(71) Applicant: Mellanox Technologies, Ltd., Yokneam (IL)

(72) Inventors: Yuval Shpigelman, Netanya (IL); Elazar Cohen, Haifa (IL); Yamin Friedman, Jerusalem (IL); Ariel Shahar, Jerusalem (IL); Roee Moyal, Yokneam Illit (IL); Shay Aisman, Zichron Yaakov (IL); Avi Urman, Yokneam (IL); Doron Haim, Herzliya (IL); Saar Tarnopolsky, Haifa (IL); Amir Sharaffy, Ashkelon (IL)

(21) Appl. No.: 19/067,914

(22) Filed: Mar. 2, 2025

Related U.S. Application Data
(60) Provisional application No. 63/561,346, filed on Mar. 5, 2024.

(51) Int. Cl. H04L 47/625; H04L 47/12; H04L 49/00

(52) U.S. Cl. CPC H04L 47/6255; H04L 47/12; H04L 49/3063

(57) ABSTRACT

A network device includes a hardware-implemented packet processing pipeline includes: multiple pipeline stages, and a processor. The hardware-implemented packet processing pipeline is to process packets exchanged with a packet network. The processor is to execute sideband tasks for the packet processing pipeline. At least one of the pipeline stages is to trigger the processor to execute a sideband task by posting a Completion-Queue Element (CQE) on a Completion Queue (CQ) accessible to the processor.

### CROSS REFERENCE TO RELATED APPLICATIONS

This application claims the benefit of U.S. Provisional Patent Application 63/561,346, filed Mar. 5, 2024, whose disclosure is incorporated herein by reference.

### TECHNICAL FIELD

The present disclosure relates to network devices, and in particular, to an interface for providing computation tasks to a network device using a sideband that comprises Completion Queue Elements (CQEs).

### BACKGROUND

Network devices such as Network Interface Controllers (or, generally, any computing devices that are connected to a packet network) typically perform two types of packet processing flow: a per-packet main flow, which is triggered for every packet, and a less frequent auxiliary flow, typically invoked once every several packets. The auxiliary flow includes, for example, tasks related to acknowledgments, telemetry, and congestion control. Auxiliary flow tasks often include computation-based control algorithms (e. g., congestion control, path selection, network statistics, transport non-mainstream assistance, transport sideband protocols support, and inband telemetry), which may be executed by a dedicated processor. However, as packet rates scale faster than silicon speed, incorporating a dedicated processor into the main pipeline for performing these computation-based tasks becomes increasingly challenging. A more efficient approach is to handle these flows in a sideband processing track.

### SUMMARY

An embodiment that is described herein provides a network device including a hardware-implemented packet processing pipeline that includes multiple pipeline stages, and a processor. The hardware-implemented packet processing pipeline is to process packets exchanged with a packet network. The processor is to execute sideband tasks for the packet processing pipeline. At least one of the pipeline stages is to trigger the processor to execute a sideband task by posting a Completion-Queue Element (CQE) on a Completion Queue (CQ) accessible to the processor.

In an example embodiment at least one of the pipeline stages comprises an ingress-packet pipeline stage. In another example embodiment at least one of the pipeline stages comprises an egress-packet pipeline stage.

In some embodiments, the network device further includes a host processor, to process incoming packets and generate outgoing packets via the packet processing pipeline. In a disclosed embodiment, the host is further to execute at least part of the sideband tasks. In embodiments, the processor is to further read the CQE from the co and to execute the sideband task specified by the CQE.

In some embodiments, two or more different pipeline stages in the packet processing pipeline are to trigger the processor to execute two or more respective different types of sideband tasks. In a disclosed example embodiment, the processor includes a flow-control circuit, to control the CQ.

In some embodiments, the CQ is to send a CQ status-indication signal to the processor according to a fill measure of the CO. In an embodiment, the CQ status-indication signal includes a processor interrupt.

In example embodiments, the sideband task includes congestion detection and notification, congestion detection and mitigation, acknowledgement packet processing, multipath processing, telemetry packet processing, network time measurement processing, Reliable Transport Time measurements, trimmed packet arrival processing, Implicit Loss Indication (ILI) processing, Explicit Congestion Notification (ECN) processing, tracking egress packets that meet preset criteria, and/or duplicate ingress packet processing.

There is additionally provided, in accordance with an embodiment that is described herein, a method for network communication. The method includes processing packets exchanged with a packet network in a hardware-implemented packet processing pipeline that includes multiple pipeline stages, coupling a processor to execute sideband tasks for the packet processing pipeline, initiating execution of a sideband task by posting, by one of the pipeline stages, a Completion-Queue Element (CQE) on a Completion Queue (CQ) accessible to the processor, and executing the sideband task by the processor in response to the CQE.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a Network Device, in accordance with an embodiment that is disclosed herein;

FIG. 2 is a block diagram that schematically illustrates an RDMA-Enabled Network Interface Controller (RNIC), in accordance with an embodiment that is disclosed herein;

FIG. 3 is a flowchart that schematically illustrates a method for sideband task interface in a Network Device, in accordance with an embodiment that is disclosed herein; and

FIG. 4 is a block diagram that schematically illustrates a Computing System, e.g., a data center or a High-Performance Computing (HPC) cluster, in accordance with an embodiment that is described herein.

### DETAILED DESCRIPTION OF EMBODIMENTS

### Overview

In embodiments, a network device comprises a pipeline circuit that executes a per-packet main flow and a dedicated sideband processor that executes compute-intensive (but typically infrequent) tasks, referred to as sideband tasks. The pipeline processor executes tasks that the host submits to a Work Queue (WQ), which holds Work-Queue Elements (WQEs), and sends completion indications corresponding to the WQEs to the host, via a Completion Queue (CQ), which holds Completion Queue Elements (CQEs).

One way to incorporate the sideband processor in the network device is to send a copy of any packet that requires sideband processing to a dedicated queue in the sideband processor space. This approach, however, consumes internal pipeline circuit processing bandwidth for the duplication of the packets, requires full packet processing functions in the sideband path (e.g., parsing and storage), and requires additional metadata to be attached to the packet by the pipeline circuit.

Embodiments that are disclosed below implement a simple packet-like interface between the pipeline circuit and an auxiliary sideband processing pipeline. This interface seamlessly integrates with the per-packet processing pipeline and sends tasks to the sideband processor.

In embodiments, one or more pipeline stages of the pipeline circuit send Completion Queue Elements (CQEs) to the sideband processor. COEs conventionally serve as indicators for software to report the completion of a WQE that the network device sends to the host. The CQEs naturally accumulate in a queue, which triggers an interrupt to the host. In the present embodiments, however, the CQEs will originate directly from the pipeline circuit, and will include packet data and metadata generated by the pipeline circuit, leveraging its natural capability to extract information from the packet or from the state (metadata) associated with the packet being processed.

The ability to create a per-use-case, customized metadata format for communication between the pipeline circuit and the sideband processor minimizes overhead while enabling optimized and efficient handling of sideband processing tasks.

### System Description

In embodiments, a sideband processor receives sideband task for execution through a Completion Queue. Although the queue is referred to as a Completion Queue, it does not indicate completion of tasks but, rather, specifies tasks to be executed by the sideband processor, using the same format and mechanisms that the pipeline circuit uses to send actual completion indications to the host.

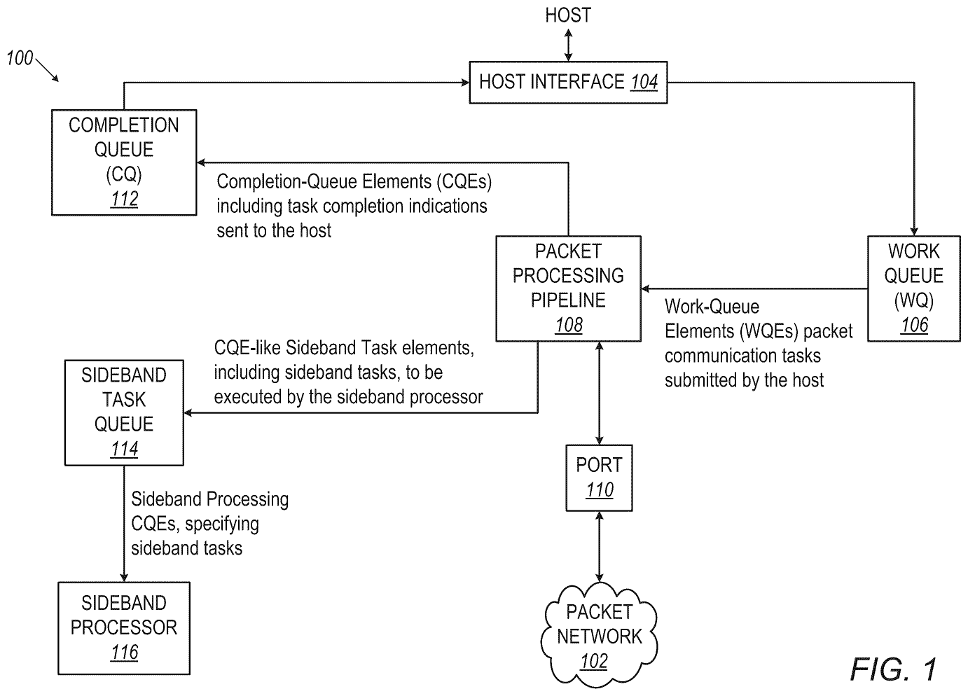

FIG. 1 is a block diagram that schematically illustrates a Network Device 100, in accordance with an embodiment that is disclosed herein. The Network Device communicates data packets between a host (not shown) and a packet network 102. In some embodiments, Network Device 100 is configured to implement a Remote Direct Memory Access (RDMA) protocol.

According to the example embodiment illustrated in FIG. 1, Network Device 100 communicates with the Host through a Host Interface 104, e.g., a Peripheral Component Interconnect Express (PCIe) interface. Other interface protocols, such as Universal Serial Bus (USB) 4, may be used in alternative embodiments.

The host sends Work Queue Elements (WQEs) to a Work-Queue (WQ) 106 in the Network Device. Each WQE specifies a network-related task. In embodiments, the WQ comprises a First-In-First-Out (FIFO) memory. A Packet Processing Pipeline 108 reads the WQEs from the WQ 106 and executes the specified tasks, communicating packets with the Packet Network 102 through a Port 110. In some embodiments, Packet Processing Pipeline 108 comprises hardware-implemented circuitry, which executes one or more of the seven layers of the Open Systems Interconnection (OSI) model; in embodiments, Port 102 executes the PHY layer.

When the Packet Processing Pipeline 108 completes the execution of a task (e.g., a task specified by a corresponding WQE), the Packet Processing Pipeline stores a Completion Queue Element (CQE) in a Completion Queue (CQ) 112. (Since CQ 112 typically comprises a FIFO, we will refer to storing data in the CO as Pushing, and to reading data from the CQ, as Pulling.) The CQE may include, for example, an ID code of the corresponding WQE, a fail/pass indication and various other metadata. In some embodiments CQ 112 comprises a FIFO memory that sends CQEs through Host Interface 104, to the Host; in an embodiment, the Host Interface sends an interrupt to the Host according to a fill measure of the CQ.

According to the example embodiment illustrated in FIG. 1, Network Device 100 further comprises a Sideband Task Queue 114, to store sideband tasks that are to be executed by a Sideband Processor 116 (e.g., a Reduced Instruction Set (RISC) processor). The Packet Processing Pipeline 108 generates sideband task elements that specify sideband tasks in a format that is similar to the CQE format (referred to as Sideband Processing CQEs) and stores the elements as entries in the Sideband Task Queue. In an embodiment, both CQ 112 and Sideband Task Queue 114 comprise FIFO memories; CQ 112 is written by the Packet Processing Pipeline 108 and read by Host Interface 104, whereas Sideband Task Queue 114 is written by the Packet Processing Pipeline 108 and read by the Sideband Processor 116.

In embodiments, various subunits of the packet processing pipeline, handling various pipeline stages, may send Sideband Processing CQEs to the Sideband Processor. In an embodiment, the subunits comprise ingress packet processing subunits; in another embodiment, the subunits comprise egress Packet Processing subunits; and, in yet another embodiment, the subunits may comprise both ingress and egress packet processing subunits.

In an alternative embodiment, there is no Sideband Task Queue, and instead the Packet Processing Pipeline sends Sideband Processing CQEs to specify sideband processes to Sideband Processor only.

In some embodiments, the Network Device comprises a host that sends and receives network packets. In an embodiment, the host is configured to process sideband tasks in response to Sideband Processing CQEs (that are sent over the Host Interface 104); in an embodiment, both the host and the Sideband Processor execute the sideband tasks, e.g., the Sideband Processor may execute tasks that require short latency, while the host may executes less-urgent but possibly compute-intensive tasks.

Thus, according to the example embodiment illustrated in FIG. 1 and described hereinabove, a Packet Processing Pipeline in a Network Device can send sideband tasks to an embedded sideband processor, reusing formats that are otherwise used for sending completion indications to the host.

The configuration of Network Device 100 described above is cited by way of example. Other configurations may be used in alternative embodiments. For example, in some embodiments, a shared single-input dual-output CQ FIFO is used, written by the Packet Processing Pipeline and read by either the Host Interface or the Sideband Processor, according to a Destination field (e.g., a bit) that is added to each CQE. In another embodiment, a single processor initiates the communication of network packets and executes some or all the sideband processing tasks. In yet another embodiment, Sideband Processor 114 comprises a plurality of processors, of the same or of different types (e.g., a security sideband processor to execute encryption and decryption, and a general-purpose processor to handle all other sideband tasks).

In some embodiments, various stages of the Packet Processing Pipeline can push Sideband Processing CQEs into the CQ. In an embodiment, the Sideband Processor uses a flow-control circuit to enable additional CQEs and avoid CQ overrun (for example, using producer/consumer counters). In some embodiments the processor reads a COE from the CQ when the CQ is not empty; in other embodiments, the CQE may initiate a sequence that ends with interrupt to the Sideband Processor, which, responsively, reads the CQE from the CQ.

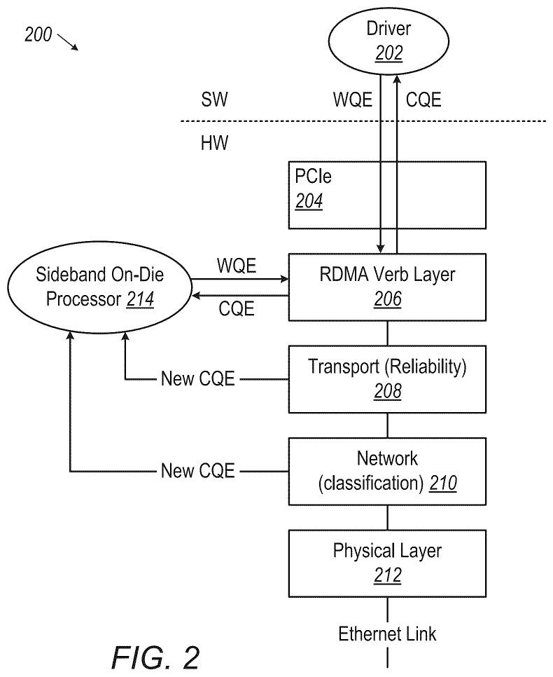

FIG. 2 is a block diagram that schematically illustrates an RDMA-Enabled Network Interface Controller (RNIC) 200, in accordance with an embodiment that is disclosed herein. RNIC 200 communicates packets between a host 202 and a packet network (not shown), through an Ethernet link. (Other links, such as InfiniBand, can be used in alternative embodiments.)

RNIC 200 processes communication packets in a hardware-implemented pipeline that comprises a Host Interface (e.g., PCIe) 204 to interface with the Host; an RDMA Verb Layer circuit 206, to interpret the various RDMA verbs; a Transport Layer circuit 206 to implement the Transport layer of the protocol, including reliability assurance; a Network Layer circuit 210, to classify the communicated packets; and a Physical Layer circuit 212, to handle frame and bit level signaling (including the Data-Link layer and the Physical layer of the 7-layer OSI communication model).

RDMA Verb Layer circuit 206, Transport Layer circuit 208 and Network Layer circuit 210 are together referred to as the Packet Processing Pipeline, as described with reference to FIG. 1 above.

The host may send WQEs to the Packet Processing Pipeline, to initiate the execution of packet processing tasks by the Packet Processing Pipeline; upon the completion of the packet processing tasks, the Packet Processing Pipeline sends respective CQEs to the host.

RNIC 200 further comprises a Sideband On-Die Processor 214, which is configured to execute sideband processing tasks. In some embodiments, Sideband Processor 214 is further configured to send RDMA WQEs to the Verb Layer circuit 206, which, responsively, executes RDMA-Verb tasks, and send respective Completion Indications (e.g., CQEs) to the Sideband Processor.

According to the example embodiment illustrated in FIG. 2, various circuits of the Packet Processing Pipeline (e. g., various pipeline stages), such as Transport Layer circuit 208 and Network Layer circuit 210, may initiate sideband processing tasks, to be executed by the Sideband Processor 214, by sending suitable CQEs (designated New CQEs) to the Sideband Processor. In embodiments, the Sideband Processor may comprise a dedicated CQ for such New CQEs, or, in other embodiments, the same CQ may be used for both the New CQEs (which specify sideband tasks) and the CQEs that the RDMA Verb Layer circuit sends (which indicate packet processing task completions).

Thus, according to the example embodiment illustrated in FIG. 2 and described above, packet-processing pipeline stages of RNIC 200 are configured to initiate sideband processing tasks for execution by the sideband processor, by reusing CQE format and mechanisms.

### Sideband Processing Use Cases

In embodiments, the sideband processing tasks that the sideband processor may execute in response to the New CQEs may comprise, for example:
a. Congestion Notification, wherein the Sideband Processor detects congestion, e.g., according to the lengths of the queues, and sends suitable notifications to the Host (which may take corrective measures to reduce the packet rate).
b. Congestion Mitigation, wherein the Sideband b. Processor detects congestion and, responsively, takes corrective measures, e.g., increases the sizes of the queues.
c. Handling of acknowledgement packets. For example, the Sideband Processor may resend a packet to a peer if the peer returns a negative acknowledge packet, or if the sideband processor does not receive an acknowledge packet from the peer within a given time period.
d. Multipath processing, wherein the Sideband Processor runs an algorithm that manages the balancing of traffic from the network into the Network Device across all possible paths. In this mode the routing of a packet within the packet network is defined at the sender network device. The algorithm includes a routing table in the Packet Processing Pipeline, managed by the Sideband Processor. The Sideband Processor collects events from the RX path, including congestion and dropped-packets indications, and translates them into routing decisions.
e. Telemetry processing, wherein the Sideband Processor processes control packets associated with telemetry information.
f. Network Time Measurements (Round-Trip Time, or RTT). The Sideband Processor measures the time from an egress RTT-request packet to an ingress response packet from the same IP address. CQEs may be used to indicate egress-packet time and ingress-packet time, and the respective peer IP addresses.
g. Reliable Transport time measurement—the Sideband Processor starts a timer when a packet is sent and indicates a lost packet if no response is received within a preset time.
h. Trimmed packet arrival processing. The packet has been trimmed to include header only (e.g., as a result of a “buffer full” event in a network switch). The Sideband Processor, in response to the trimmed packet, will trigger a NACK (so that the peer can retransmit).
i. Implicit Loss Indication (ILI) processing. A packet that follows a data packet on the same route is received, but without the data packet. The Sideband Processor will, responsively, trigger a NACK packet.
j. Explicit Congestion Notification (ECN) processing. Responsively to receiving an ingress packet with an ECN indication (typically added by a congested switch in the network), the Sideband Processor sends a “slow-down” indication to the host.
k. Tracking egress packets that meet preset criteria; for example, the Sideband Processor counts packets or accumulates payloads that the packet Processing Pipeline sends to a given address or via a given route.
l. Duplicate ingress packet processing. The Receipt of a duplicate packet may indicate that the peer executed a RETRY too early. The Sideband Processor may, responsively, trigger a respective alert packet to be sent to the peer.

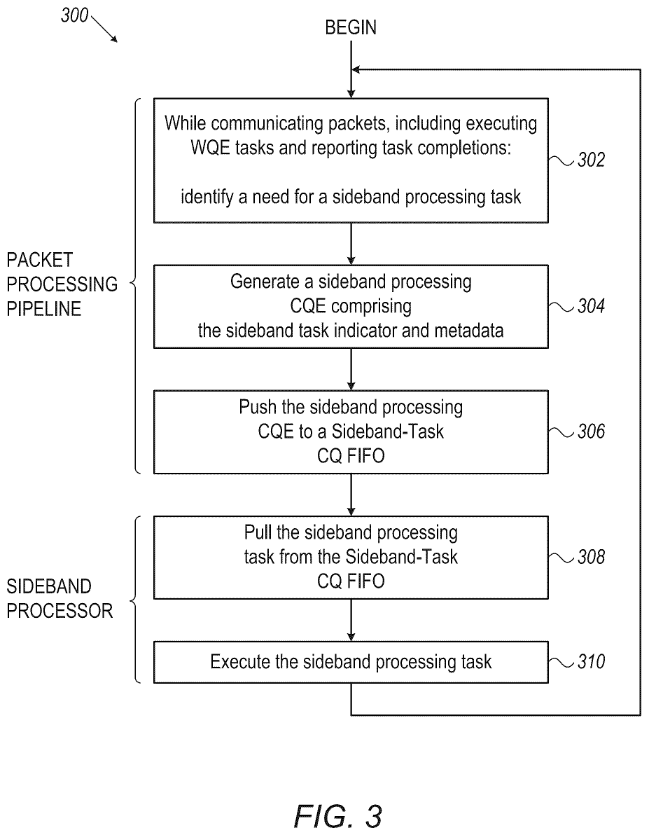

FIG. 3 is a flowchart 300 that schematically illustrates a method for sideband task interface in a Network Device, in accordance with an embodiment that is disclosed herein. The flowchart is executed by Packet Processing Pipeline 108 and Sideband Processor 116 (FIG. 1).

The flowchart begins at an Identify-Need-for-a-Processing-Task operation wherein the 302, Packet Processing Pipeline, while communicating packets according of WQEs, identifies a sideband task to be to a group executed by the Sideband Processor 116. In response to identifying the sideband task, the Packet Processing Pipeline generates a COE that specifies the requested sideband task in a Generate Sideband Processing CQE operation 304 and includes any metadata thereof. (Despite what its name implies, the task specification CQE is not related to task Completion but, rather, to the triggering of a sideband processing task.)

Next, at a Push-CQE operation 306, the Packet Processing Pipeline pushes the Sideband-Task CQE into a Completion Queue, typically comprising a FIFO memory.

NOW, at a Pull-Sideband-Task operation 308 the Sideband Processor reads a COE from the Completion Queue; in embodiments, the Completion Queue comprises a FIFO, and the Sideband Processor will read (“Pull”) the oldest entry.

Lastly, at an Execute-Sideband-Task operation 310, the Sideband Processor executes the sideband task specified by the pulled CQE. After operation 310, the flowchart reenters operation 302, to identify and execute the next sideband processing task.

The configuration of flowchart 300 illustrated in FIG. 3 and described hereinabove is cited by way of example. Other flowcharts may be used in alternative embodiments. For example, in some embodiments the same CQ is used for specifying tasks to be executed by the Sideband Processor and to indicate completions to the Host (in which case, a field in the COE may be used to indicate the CQE destination).

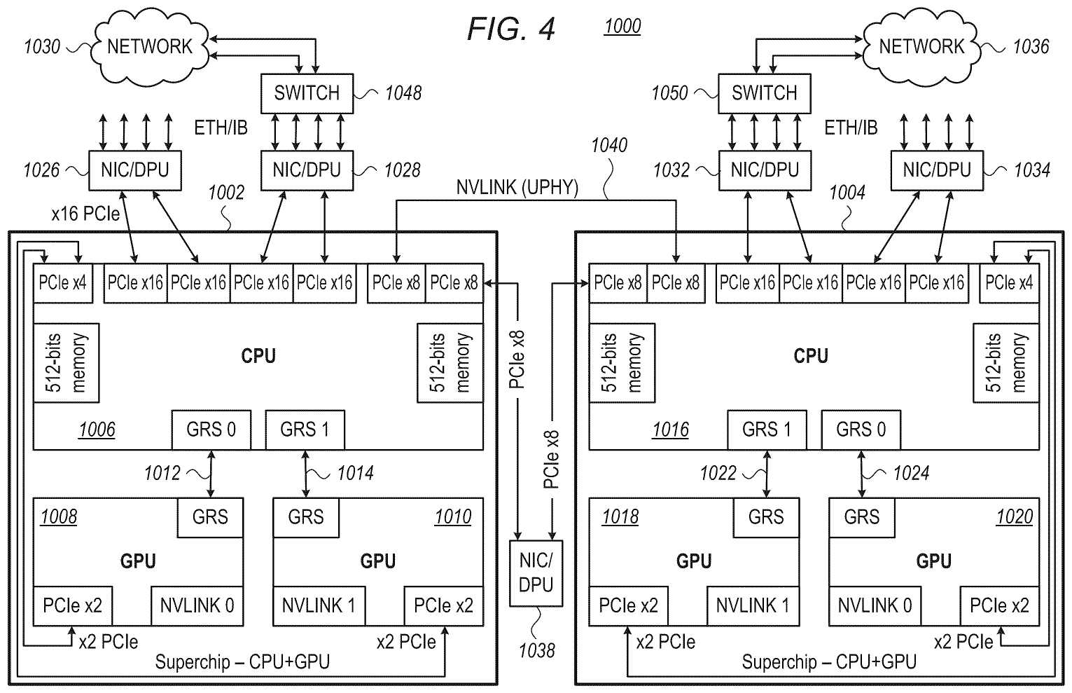

FIG. 4 is a block diagram that schematically illustrates a Computing System 1000, e.g., a data center High-Performance Computing (HPC) cluster, or a in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), wherein each integrated circuit can include one or more CPUs and GPUs, forming a powerful and flexible architecture. In embodiments, the various elements of Computing System 1000 may comprise the sideband interface circuitry described above with reference to FIGS. 1 through 3.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 4 also demonstrates an example of a multi-GPU architecture. As illustrated in the figure, computing system 1000 includes a processing device 1002 with a multi-GPU architecture. In particular, processing device 1002 may be a system-on-chip and includes multiple subsystems, such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, includes multiple subsystems processing device 1004 including a CPU 1016, a GPU 1018, and a GPU 1020. CPU 1016 can be coupled to GPU 1018 via a D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communicate with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices of system 1000, e.g., any of NICs/DPUS 1026, 1028, 1032, 1034 and 1038, and/or any of CPUs 1006, 1016, GPUs 1008, 1010, 108 and 1020 may comprise a scheduler an a plurality of multi-thread processors, wherein the scheduler is configured to assign tasks to threads of the multi-thread processors while optimizing for power consumption or for performance, in accordance with the techniques described herein.

The apparatuses and methods described hereinabove, with reference to FIGS. 1, 2, 3 and 4, including the configuration of Flowchart 300, Network Devices 100, 200, computing system and 1000 and including all units and subunits thereof, are example configurations and methods that are shown purely for the sake of conceptual clarity. Any other suitable methods and configurations can be used in alternative embodiments.

In various embodiments, Network Devices 100 and 200, including subunits thereof, may be implemented using suitable hardware, such as one or more Application-Specific Integrated Circuits (ASIC) or Field-Programmable Gate Arrays (FPGA), or a combination of ASIC and FPGA.

Sideband Processors 116 and 214 typically comprise a general-purpose computer, which is programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

Although the embodiments described herein mainly address the invocation of sideband processing tasks in a network device, the methods and systems described herein can also be used in other applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
a hardware-implemented packet processing pipeline comprising multiple pipeline stages, to process packets exchanged with a packet network; and
a processor, to execute sideband tasks for the packet processing pipeline,
wherein at least one of the pipeline stages is to trigger the processor to execute a sideband task by posting a Completion-Queue Element (CQE) on a Completion Queue (CQ) accessible to the processor.

2. The network device according to claim 1, wherein the at least one of the pipeline stages comprises an ingress-packet pipeline stage.

3. The network device according to claim 1, wherein the at least one of the pipeline stages comprises an egress-packet pipeline stage.

4. The network device according to claim 1, further comprising a host processor, to process incoming packets and generate outgoing packets via the packet processing pipeline.

5. The network device according to claim 4, wherein the host is further to execute at least part of the sideband tasks.

6. The network device according to claim 1, wherein the processor is to read the CQE from the CQ and to execute the sideband task specified by the CQE.

7. The network device according to claim 1, wherein two or more different pipeline stages in the packet processing pipeline are to trigger the processor to execute two or more respective different types of sideband tasks.

8. The network device according to claim 7, wherein the two or more different pipeline stages are to provide the processor with two or more respective different sets of metadata for executing the two or more different types of sideband tasks.

9. The network device according to claim 1, wherein the processor comprises a flow-control circuit, to control the CQ.

10. The network device according to claim 1, wherein the CQ is to send a CO status indication signal to the processor according to a fill measure of the CQ.

11. The network device according to claim 10, wherein the CQ status indication signal comprises a processor interrupt.

12. The network device according to claim 1, wherein the sideband task comprises congestion detection and notification.

13. The network device according to claim 1, wherein the sideband task comprises congestion detection and mitigation.

14. The network device according to claim 1, wherein the sideband task comprises acknowledgement packet processing.

15. The network device according to claim 1, wherein the sideband task comprises multipath processing.

16. The network device according to claim 1, wherein the sideband task comprises telemetry packet processing.

17. The network device according to claim 1, wherein the sideband task comprises network time measurement processing.

18. The network device according to claim 1, wherein the sideband task comprises Reliable Transport Time measurements.

19. The network device according to claim 1, wherein the sideband task comprises trimmed packet arrival processing.

20. The network device according to claim 1, wherein the sideband task comprises Implicit Loss Indication (ILI) processing.

21. The network device according to claim 1, wherein the sideband task comprises Explicit Congestion Notification (ECN) processing.

22. The network device according to claim 1, wherein the sideband task comprises tracking egress packets that meet preset criteria.

23. The network device according to claim 1, wherein the sideband task comprises duplicate ingress packet processing.

24. A method for network communication, comprising:
processing packets exchanged with a packet network in a hardware-implemented packet processing pipeline comprising multiple pipeline stages;
coupling a processor to execute sideband tasks for the packet processing pipeline;
initiating execution of a sideband task by posting, by one of the pipeline stages, a Completion-Queue Element (CQE) on a Completion Queue (CQ) accessible to the processor; and
executing the sideband task by the processor in response to the CQE.

25. The method according to claim 24, wherein the pipeline stage comprises an ingress-packet pipeline stage.

26. The method according to claim 24, wherein the pipeline stage comprises an egress-packet pipeline stage.

27. The method according to claim 24, further comprising coupling a host processor, to process incoming packets and generate outgoing packets via the packet processing pipeline.

28. The method according to claim 27, wherein the host is further to execute at least part of the sideband tasks.

29. The method according to claim 24, wherein executing the sideband task comprises reading the CQE from the CQ by the processor.

30. The method according to claim 24, wherein initiating the execution comprises posting two or more CQEs by two or more different pipeline stages in the packet processing pipeline to trigger the processor to execute two or more respective different types of sideband tasks.

31. The method according to claim 30, wherein posting the two or more CQEs comprises providing two or more respective different sets of metadata by the two or more different pipeline stages to the processor for executing the two or more different types of sideband tasks.

32. The method according to claim 24, further comprising controlling the flow of the CQ.

33. The method according to claim 24, further comprising sending a CQ status-indication signal to the processor according to a fill measure of the CQ.

34. The method according to claim 33, wherein the CQ status-indication signal comprises a processor interrupt.

35. The method according to claim 24, wherein the sideband task comprises at least one task selected from: congestion detection and notification, congestion detection and mitigation, acknowledgement packet processing, multipath processing, telemetry packet processing, network time measurement processing, Reliable Transport Time measurements, trimmed packet arrival processing, Implicit Loss Indication (ILI) processing, Explicit congestion notification (ECN) processing, tracking egress packets that meet preset criteria and duplicate ingress packet processing.
